(19) United States
(12) Patent Application Publication
(10) Pub. No.: US 2023/0126133 A1
(43) Pub. Date: Apr. 27, 2023

(54) PROGRAM ASSESSMENT AND MATCHING SYSTEM

(71) Applicant: Altus Assessments Inc., Toronto (CA)

(72) Inventors: Harold REITER, Thornhill (CA); Kelly DORE, Burlington (CA)

(21) Appl. No.: 17/451,724

(22) Filed: Oct. 21, 2021

(51) Int. Cl. G06Q 50/20; G06F 16/248

(52) U.S. Cl. CPC G06Q 50/2053; G06F 16/248

(57) ABSTRACT

Measuring the alignment of priorities or “fit” between applicants for positions and the programs offering the positions may be highly sought after but poorly defined or measured. Priorities may include the institutional or individual mission statements, values, needs, and offerings. Within higher education, current methods of assessing fit, e.g. from personal statements, reference letters, in-person or virtual interviews, typically lack standardization, encourage disingenuity, and expends a great deal of human resources. The assessment system described herein provides quantitative measures of strength of alignment that is standardized, reliable, and defensible for position-filling decision-making. Hundreds or thousands of applicants for only a few dozen positions at a plurality of different programs may be individually prioritized for each program based on each applicant and each program providing a single prioritized list of desired characteristics.

### TECHNICAL FIELD

The present disclosure relates to a program assessment system for ranking applicants for positions in desired programs, and in particular to a system and method for assessing and matching applicants to programs based on the applicant’s and the program’s ranking of a plurality of characteristics in a plurality of categories.

### BACKGROUND

When applicants apply for positions in a plurality of potential programs, e.g. educational programs, such as medical school, residency or law school, each program has the difficult task of ranking the applicants according to their basic qualifications, e.g. experience, marks, etc. However, deciding whether an applicant is a good fit for the program may not easily be determined simply by how well they did in school or at their last job. Within some complex position-filling systems, the concept of “fit” may be highly sought after, but poorly defined or measured. For example, within higher education, current methods of assessing fit, e.g. data culled from personal statements, reference letters, in-person and/or virtual interviews, typically lack standardization, encourage disingenuity, and expend a great deal of human resources.

An object of the present disclosure is to overcome the shortcomings of the prior art by providing quantitative measures of strength of alignment that are standardized, reliable, and defensible for position-filling decision-making, and providing guidance for productive changes to future iterations to enhance user goals. In particular, providing a comparison assessment system that requires input from both the applicants and representatives of the programs results in fit scores, which may be used to generate an overall ranking of applicants for each program, and a ranking of programs for each applicant, as well as useful internal data for programs to inform and guide their unique mission statements.

### SUMMARY

Accordingly, a first method comprises:
a) providing, by a processor, one or more first graphic user interfaces configured to enable each of a plurality of applicants to enter a respective first prioritized list of a first plurality of characteristics in a first category relating to one or more positions offered by each of a plurality of programs into which the plurality of applicants wish to apply;
b) providing, by the processor, one or more second graphic user interfaces configured to enable one or more representatives of each of the plurality of programs to enter a second prioritized list of the first plurality of characteristics in the first category;
c) determining, by the processor, a first ranked correlation between each first prioritized list and each second prioritized list;
d) generating, by the processor, a corresponding first fit score for each of the plurality of applicants for each of the plurality of programs based on the first ranked correlations;
e) generating, by the processor, for each of the plurality of programs, a corresponding ranked list of the applicants that applied thereto, based on the corresponding first fit scores;
f) sending the corresponding first fit score to each of the plurality of applicants for each of the plurality of programs that they applied to; and
g) sending the corresponding ranked list of the applicants to each of the plurality of programs.

Accordingly, a computing apparatus for providing a program assessment comprises:
a first processor; and
a first memory storing instructions that, when executed by the processor, configure the computing apparatus to:
a) provide one or more first graphic user interfaces configured to enable each of a plurality of applicants to enter a respective first prioritized list of a first plurality of characteristics in a first category relating to one or more positions offered by each of a plurality of programs into which the plurality of applicants wish to apply;
b) provide one or more second graphic user interfaces configured to enable one or more representatives of each of the plurality of programs to enter a second prioritized list of the first plurality of characteristics in the first category;
c) determine a first ranked correlation between each first prioritized list and each second prioritized list,
d) generate a corresponding first fit score for each of the plurality of applicants for each of the plurality of programs based on the first ranked correlations;
e) generate for each of the plurality of programs, a corresponding ranked list of the applicants that applied thereto based on the corresponding first fit scores;
f) send the corresponding first fit score to each of the plurality of applicants for each of the plurality of programs that they applied to; and
g) send the corresponding ranked list of the applicants to each of the plurality of programs.

### BRIEF DESCRIPTION OF THE DRAWINGS

Some example embodiments will be described in greater detail with reference to the accompanying drawings, wherein:

FIG. 1 is a flow chart in accordance with an assessment system of the present disclosure;

FIG. 2 illustrates a paired comparison question on a graphic user interface of the assessment system of FIG. 1;

FIG. 3 illustrates a paired comparison question with a sliding scale on a graphic user interface of the assessment system of FIG. 1;

FIG. 4 illustrates the paired comparison question of with a sliding scale of FIG. 3 with exemplary scores;

FIG. 5 illustrates the paired comparison question of with a sliding scale of FIG. 3 with exemplary scores;

FIG. 6 illustrates a table of total scores for each characteristic in a category for a plurality of representatives from a program, for paired comparison analysis without sliding scale;

FIG. 7 illustrates a table of total overall scores for obtaining an overall total score for the program and an overall prioritized list of characteristics for the program, for paired comparison analysis without sliding scale;

FIG. 8 illustrates a table of total scores for each characteristic in a category for a plurality of representatives from a program, when using sliding scale;

FIG. 9 illustrates a table of total overall scores for obtaining an overall total score for the program and an overall prioritized list of characteristics for the program, when using sliding scale;

FIG. 10A illustrates a characteristic comparison, using paired comparison analysis without sliding scale, resulting in a fit score of 100 indicating that the applicant has ranked all characteristics in the exact same order as the program rating;

FIG. 10B illustrates a characteristic comparison, using paired comparison analysis without sliding scale, resulting in a fit score of 50 indicating that the applicant and the program rankings have no discernible pattern;

FIG. 10C illustrates a characteristic comparison, using paired comparison analysis without sliding scale, resulting in a fit score of 0 indicating that the applicant has ranked all characteristics in the exact opposite order of the program rating;

FIG. 11A illustrates a list of applicants and their fit scores;

FIG. 11B illustrates the list of applicants of FIG. 11A ranked according to a first criteria, culture fit score;

FIG. 11C illustrates the list of applicants of FIG. 11A ranked according to a second criteria, pedagogy fit score;

FIG. 11D illustrates the list of applicants of FIG. 11A ranked according to a third criteria, average fit score; and

FIG. 11E illustrates the list of applicants of FIG. 11A ranked according to a fifth criteria, weighted fit score.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

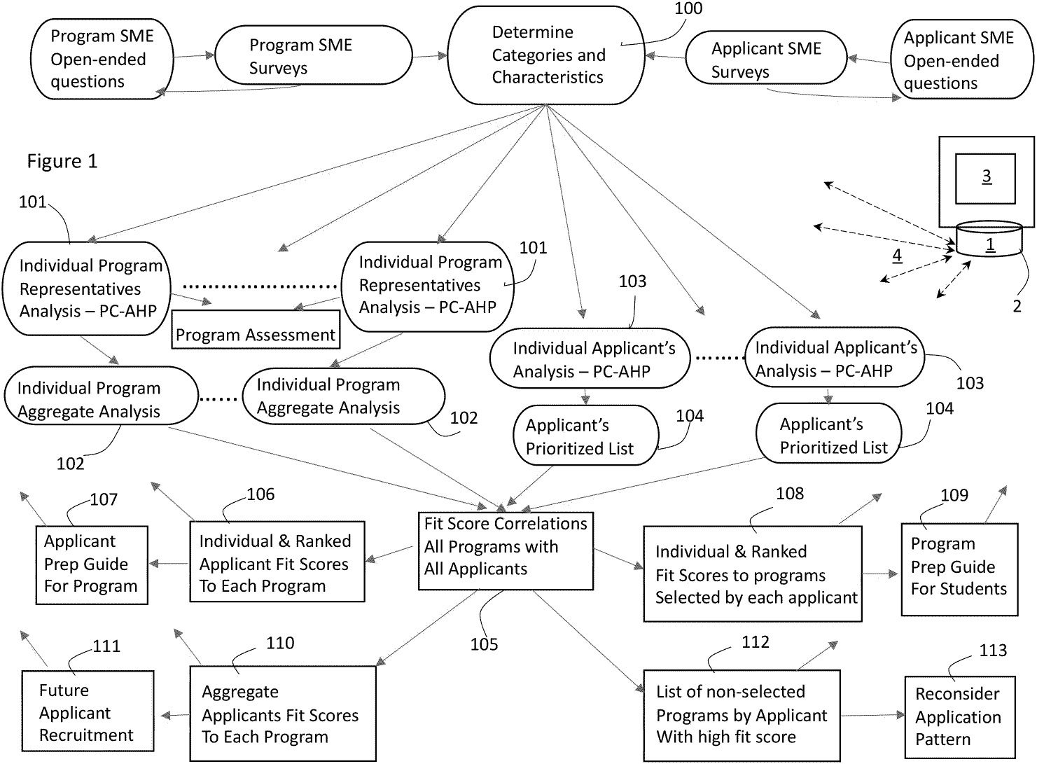

In accordance with an example embodiment, illustrated in FIG. 1, an assessment system 1 may comprise a comparison assessment designed to help identify applicants that most closely align with a program’s values and priorities, and with insight towards which applicants may be more likely to accept an offer for a position in their program. The assessment system 1 may comprise a software application with instructions stored on non-transitory memory 2 and executable by a controller processor 3, and accessible via a network 4, such as the internet. The program may be an educational program, such as a medical school, a residency program or a law school, or an employment position. Even though every applicant may not apply for the positions at every program, the assessment system 1 may generate for each program a ranked list of applicants, who have applied for the positions at that program, based on a single comparison assessment taken by every applicant and every program.

As an optional preliminary step, a list of the categories and a list of the characteristics for each category that both applicants and the programs most value, may be created by the assessment system 1 based on what one or more representatives of the program and/or one or more sample applicants consider to be the priorities and values. A structured method of communication may be conducted with representatives of both groups; these representatives are considered the Subject Matter Experts (SMEs) for the closed environment being addressed. As an example, if the closed environment comprises graduating medical students as Applicants, and United States graduate medical education (US-GME) residency training programs as programs, then two sets of SMEs may be drawn - one from among graduating medical students and one from among representatives of US-GME residency training programs. In open-ended questions, both sets of SMEs may be asked to suggest characteristics (priorities/values/characteristics) they feel important for decision-making. For applicants, what priorities guide their preferences of program; for programs what priorities guide their preference of applicants. Open-ended responses are collated. All characteristics identified by at least a threshold amount, e.g. 50%-60%, preferably 59%, of either of the two sets of SMEs are qualitatively reviewed to combine into thematic categories. A subsequent survey is sent out to the two sets of SMEs to identify, from the surviving characteristics, those that are either duplicative or unhelpful for decision-making purposes. After a second qualitative analysis of this second round of SME feedback, a final set of categorized characteristics may be produced for the specific closed environment being addressed. Typically, there will be preferably 2 –5 categories with each category comprising of preferably 5 –8 characteristics.

By selecting the categories (themes) and the characteristics each program most values and offers, the assessment system 1 may create a prioritized list of characteristics based on what one or more representatives of each program consider to be the priorities and values of the corresponding program in its current state. The prioritized lists of characteristics, based on perceptions of the program’s representatives, may be used to calculate the average or overall final prioritized list of characteristics for the program’s priorities and values.

The final prioritized list of characteristics for each program may then be compared to each of the applicant’s corresponding prioritized lists. The comparison will determine how closely the values and program offerings align to those of all the applicants’ values and preferences across a plurality of themes or categories, e.g. work environment, training methods, (pedagogy), and culture.

Since the assessment system 1 compares a total plurality of characteristics when summing across all categories, e.g. 5-30, preferably 6-24, more preferably 8-21, across a plurality of categories (themes), e.g. 2-8, preferably 2-5, more preferably 3, with each category having a plurality of characteristics within that category e.g. 4-10, preferably 5-9, more preferably 6-8, a plurality of separate assessment or “fit” scores measuring the alignment between each program and each of the applicants, i.e. one fit score for each theme for each program, may be generated.

With reference to FIG. 1, after the categories (themes) and characteristics have been determined, in step 100, e.g. as above described, a first assessment step 101 is executed, wherein a select list of representatives, e.g. 1-20, preferably 5-15, more preferably 8-12, of each program may each complete an assessment, preferably only once, which may take about 10-30, preferably 15-20, minutes to complete. Preferably, there are at least 5 programs, and more preferably more than 10 programs. Each program preferably has 5 or more spots to fill with applicants, more preferably about 5-250 spots, even more preferably about 5-20 spots or positions. Typically, there may be at least 500 applicants, often more than 1000 applicants, and sometimes more than 2000 applicants for each program; however, each applicant may only be applying for positions at selected programs, i.e. may not be applying for positions at all of the programs.

There may be a single theme or a plurality of categories (themes) of comparisons, for example: Culture, Training methods, i.e. Pedagogy, and Work Environment, depending on the type of programs and positions. For each category, time may be taken to read and reflect on the plurality of related characteristics to rank the characteristics in order of priority. Culture may be defined as the persisting ethical, collaborative, and psycho-emotional characteristics of a given program. Training methods or Pedagogy may be defined as the teaching and learning methodologies of a given program. Work Environment may be defined as the specific work conditions and setting in which trainees will perform their service. Other categories (themes) are within the scope of the invention depending on the type of programs and positions.

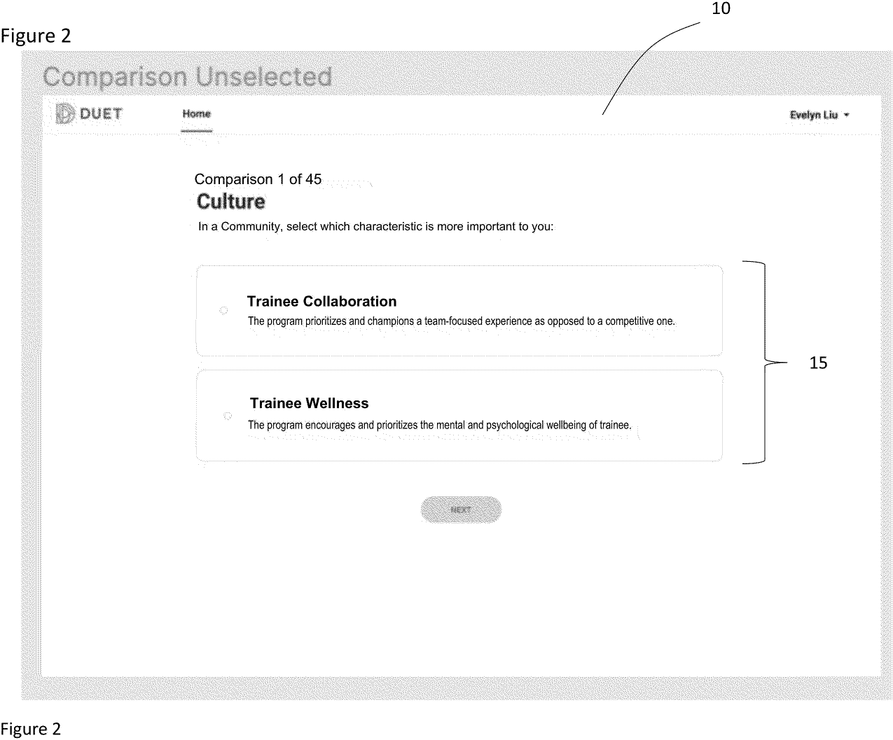

With reference to FIG. 2, the assessment system 1 may provide a graphic user interface 10, whereby the controller processor 3 via the software application is configured to illustrate the characteristics for each category (theme) two at a time e.g. a paired comparison assessment 15. The graphic user interface 10 may be accessed via a local area network or via the internet, e.g. via an application on a computer or a smart device. Each representative may then select the characteristic that they believe the program values more between the two. The representatives should consider the lens of their program and not their personal preference. The software application of the assessment system 1 presents each representative a series of pairs of characteristics, which each representative then selects their higher-ranking characteristic. The assessment system 1 comprises forced-choice comparisons and may include sliding scales. Each representative may then rank the three themes or categories in relation to one another.

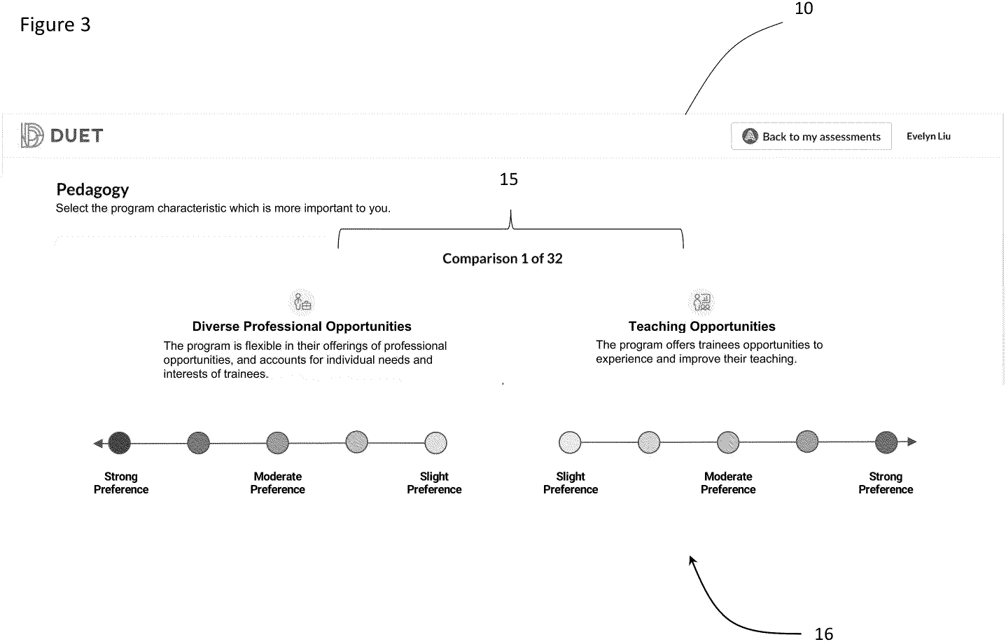

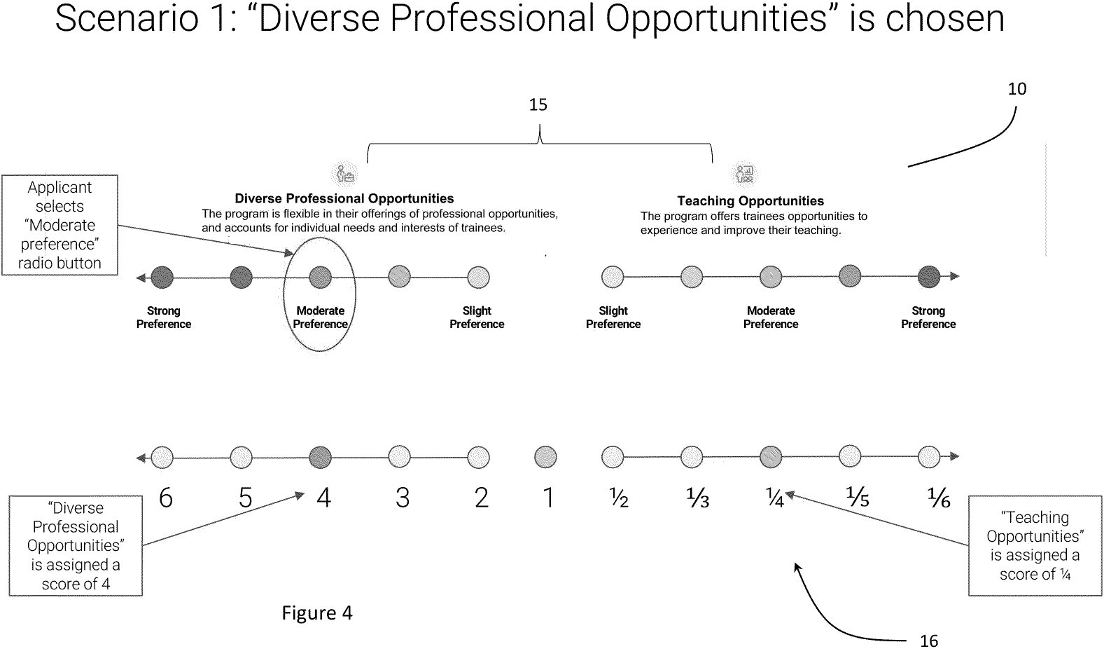

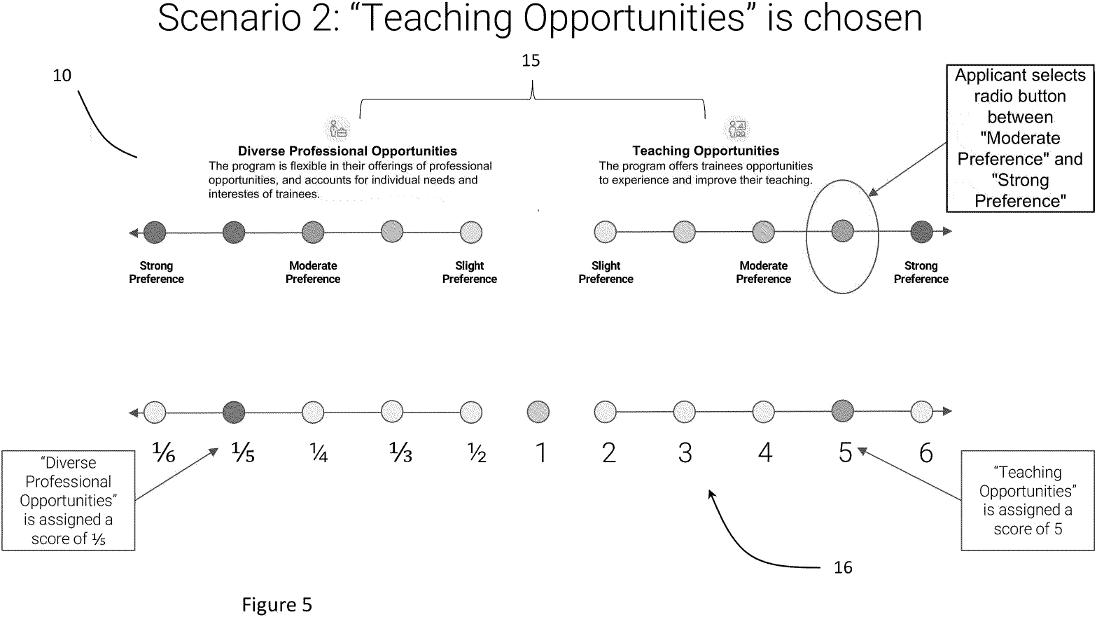

With reference to FIGS. 3-5, in an alternative example of step 101, the assessment system 1 may provide the graphic user interface 10, whereby the controller processor 3 via the software application of the assessment system 1 is configured to illustrate the characteristics two at a time e.g. the paired comparison assessment 15, but with a scaled response 16 comprising a plurality of varying degrees of preference, e.g. from a slight preference to a strong preference with one or a plurality of intermediate or moderate preferences therebetween, such as an adaptation of the Analytic Hierarchy Process (AHP) developed by Thomas L. Saaty. The standard application of the AHP is a multi-step process for each paired comparison, and is conducted using a 9-point Likert scale, which allows a neutral answer. To reduce resource intensity and time, while ensuring accuracy and an honest answer, the scale preferably comprises 3-7 different degrees of preference, more preferably 5, and the neutral answer, e.g. 1, may be eliminated. The selected answer may be given a value based on the degree of preference, from a minimum value, e.g. 2, for slight preference to a maximum value, e.g. 6, for strong preference. The corresponding degree of preference for the unselected answer may be given a value, e.g. the inverse of the value of the selected answer. For example, with reference to FIG. 4: if the representative selects a moderate preference, the answer may be awarded a score of 4, while the corresponding unselected answer may be awarded a score of 1/4. Similarly, with reference to FIG. 5: if the representative selects a moderately strong preference, the answer may be awarded a score of 5, while the corresponding unselected answer may be awarded a score of 1/5. All Applicants must fully complete all paired comparisons; a plurality of program representatives must do the same, with tags assigned to any subsets of program representatives, at the discretion of the program, e.g. a US-GME residency training program may wish to see relative alignment structures of identifiable subsets of resident trainees versus faculty representatives. If there are X categories (preferably 2–5) and N priorities within each category (preferably 5–8), the number of permutations required forced comparisons of factors and of categories are X(N^{∗}(N-1)/2) and X(X-1)/2 respectively.

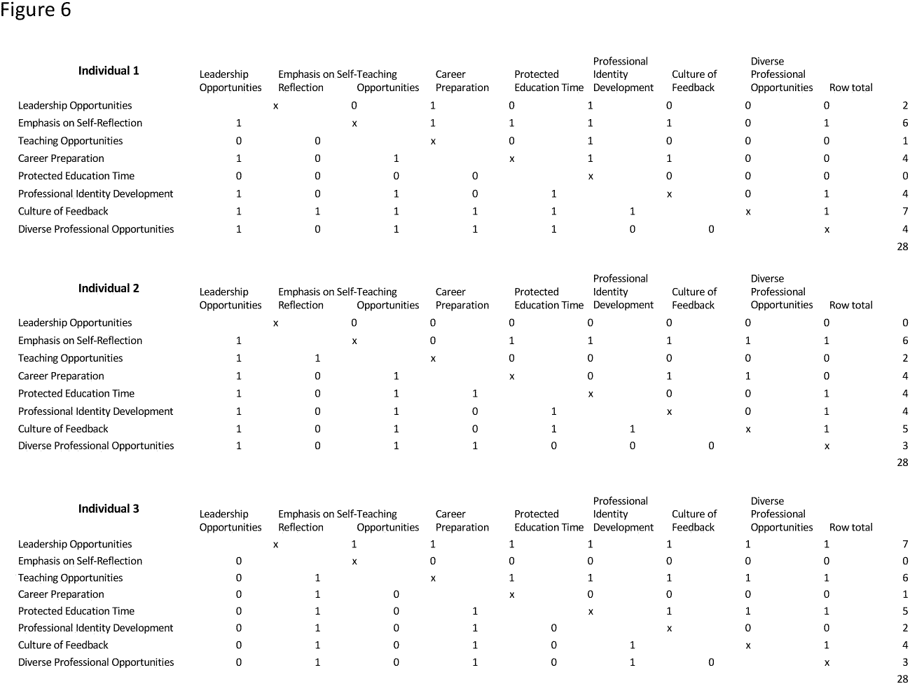

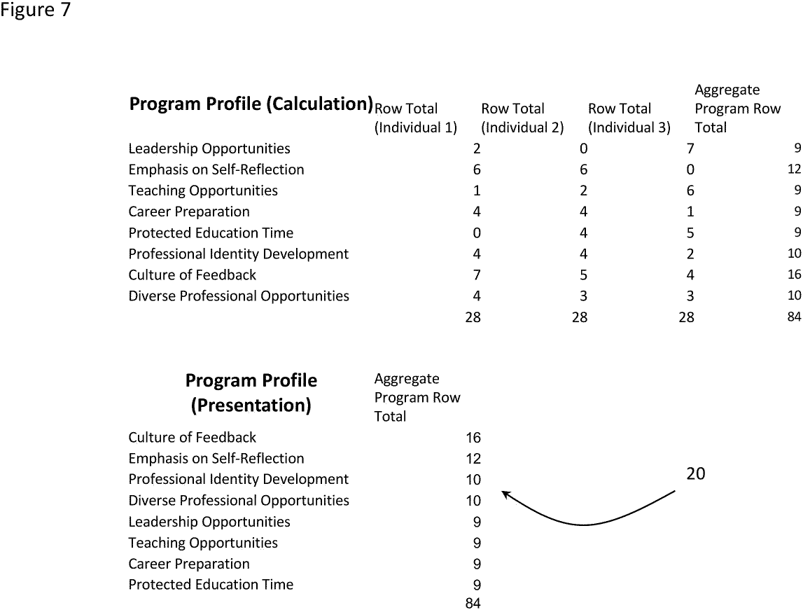

With reference to FIG. 6, in a first example step 102 the assessment system 1, using paired comparison without sliding scale, may then receive, store and tabulate the result of each paired comparison assessment 15 for each combination of characteristics resulting in a total score for each characteristic up to N-1, e.g. 7, where N is the number of characteristics, e.g. 8, and a total of N(N-1)/2 points, e.g. 28, awarded. The step 102 may be conducted for each category and for each representative, e.g. Individual 1, Individual 2 and Individual 3. With reference to FIG. 7, the assessment system 1 may then tabulate and compile a total overall score for each characteristic for the program by adding the total score from each characteristic for each representative. A program’s overall prioritized list of characteristics 20 may then be generated by the assessment system 1 based on the individual total scores of each characteristic for each representative.

The program’s overall prioritized list of characteristics 20 may be an average of the total scores or ranks of each representative or by some other means, e.g. weighted averages, in which selected representatives may have more influence on the final prioritized list. The first step 101 and/or the second step 102 may be repeated a plurality of times, e.g. for each category, for each representative, and for each of the plurality of programs participating.

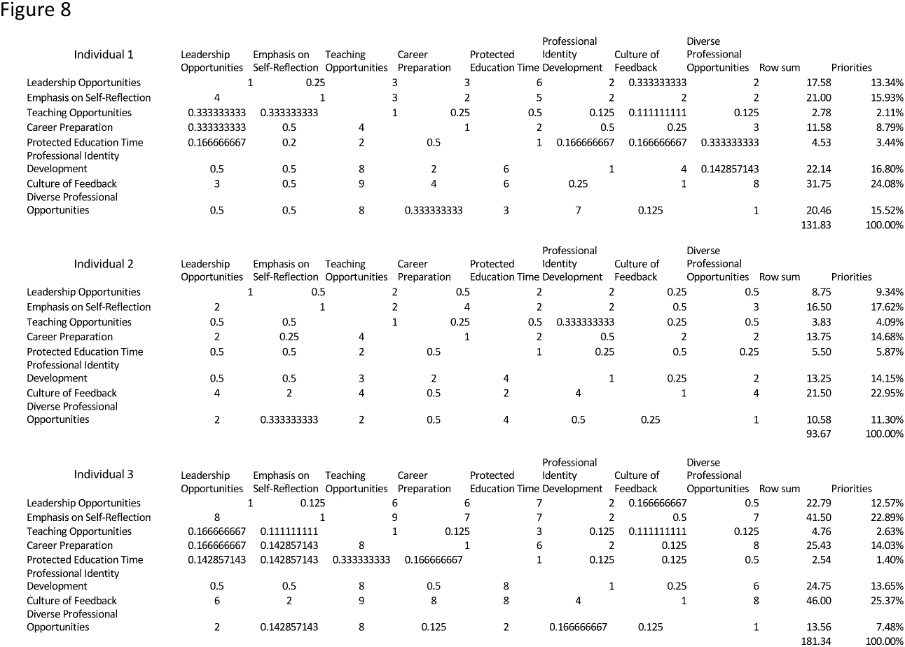

With reference to FIG. 8, in an alternative step 102 the assessment system 1 may then receive, store and tabulate the result of each paired comparison assessment 15 based on the scaled responses 16 (See FIGS. 3-5) for each combination of characteristics resulting in a total score for each characteristic. However, since the amount of total points awarded for each category may vary, simply averaging the total scores for each characteristic will not generate an accurate representation. Accordingly, a percentage of the total score for each characteristic to the total points awarded for all of characteristics in the entire category may be calculated for each of the characteristics and for each representative, and a prioritized list of characteristics is generated based on the percentages, e.g. highest to lowest. The step 102 may be conducted for each category and for each representative, e.g. Individual 1, Individual 2 and Individual 3. By convention using this sliding scale method, the sum total of points awarded to all characteristics within a single category must add up to 100%.

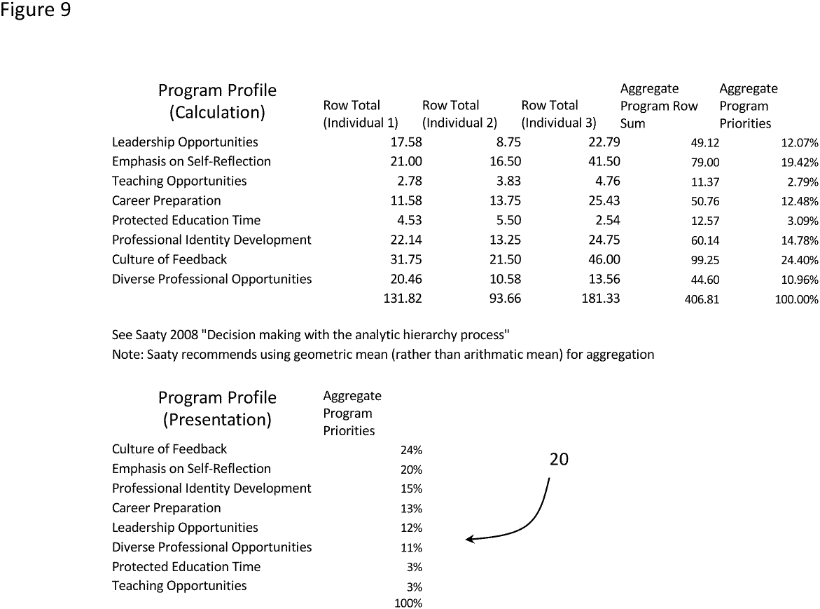

With reference to FIG. 9, the assessment system 1 may then tabulate and compile a total overall score (percentage) for each characteristic for the program based on the total score (percentage) from each characteristic for each representative, e.g. a total of all actual scores from each characteristic from each representative divided by the total of all of the total points awarded for all of the characteristics and all of the representatives. A program’s overall prioritized list of characteristics 20 may then be generated by the assessment system 1 based on the total scores and total points or aggregated individual percentages from each representative.

At step 103, before, after or simultaneously with the first step 101 and the second step 102, each applicant may then be provided access to the assessment system 1 via a graphic user interface 10, as hereinbefore described, to complete the assessment, e.g. a paired comparison assessment 15 binary or scaled, designed to help identify the alignment between the applicants’ and the programs’ values and priorities. As above, there may be at least 500 applicants, and often more than 1000 applicants for each program. Each applicant may apply to only a select number of programs based on their choice or on a predetermined maximum.

By ranking each applicant’s characteristics across the one or more categories (themes), the assessment system 1 may calculate the alignment between each applicant and each program based on the one or more categories (themes), e.g. work environment, culture and training methods (pedagogy). The assessment system’s comparison may determine how closely the values and preferences of each applicant align to the values and preferences of the programs they are applying to in a more objective way.

Each applicant ideally only completes the assessment once, which may take about 10-30, preferably 15-20, minutes to complete. Each applicant may be provided more or less time than the representatives or the applicants and the representatives may be given an unlimited amount of time to complete the assessment.

As above, there may be the plurality of themes or categories of comparisons, e.g. Culture, Training Methods, i.e. Pedagogy, and Work Environment. For each category, time is taken to read the definitions of the plurality of related characteristics.

As above, the assessment application 1 may provide the characteristics to each applicant via a graphic user interface 10, two at a time, e.g. forced choice, whereby each applicant may select the characteristic and/or their degree of preference that they prefer or value more between only two choices. The selection should be based on a gut reaction, and should not be over analyzed. Accordingly, a warning and/or a time restriction may be implemented when an applicant exceeds a threshold amount of time to answer.

Finally, the one or more, e.g. three, themes or categories may be ranked by each applicant in relation to one another.

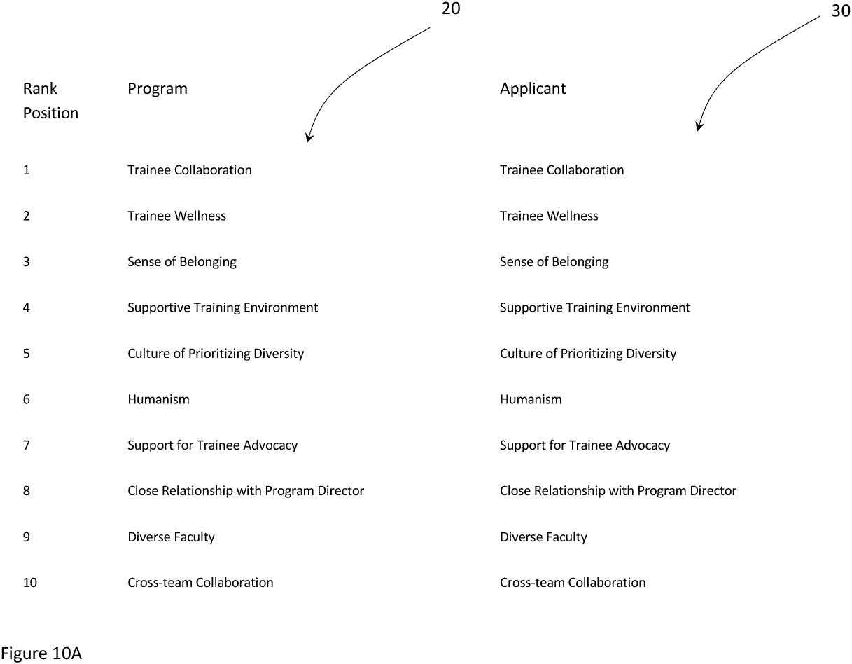

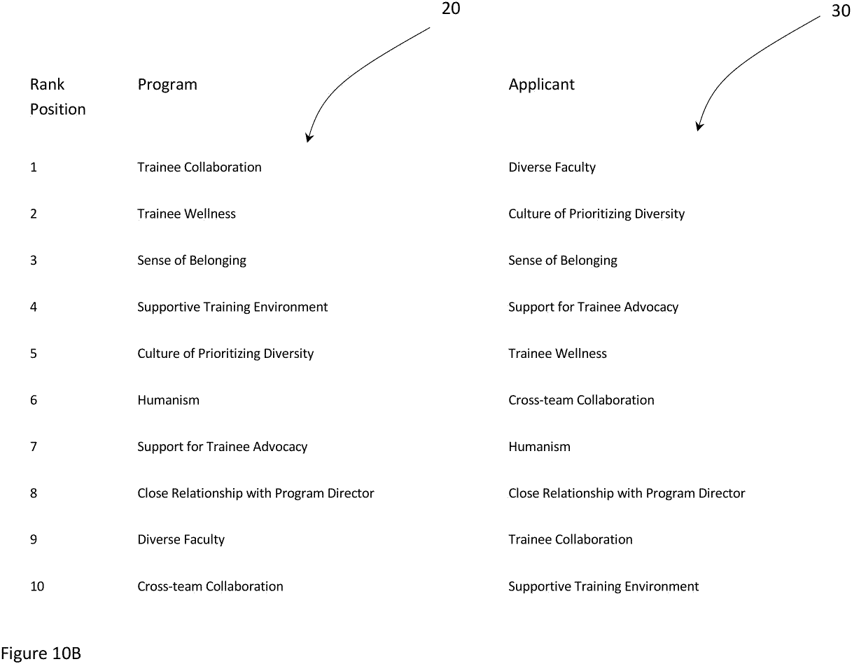

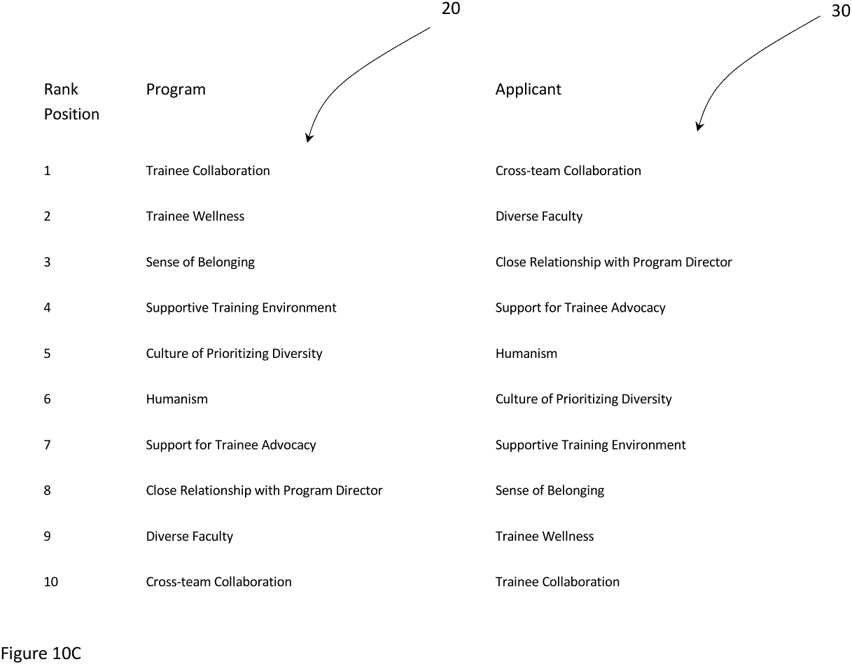

After each applicant has completed the assessment, a prioritized list of characteristics 30 for each category (theme), (FIG. 10A) may be compiled, at a fourth step 104, according to the selections provided by each applicant. Based on how they selected between all of the pairwise comparisons, each applicant will get a prioritized list of the characteristics 30 within each theme, from most important to least important.

The third step 103 and the fourth step 104 may be repeated a plurality of times, e.g. once for each category (theme), and once for each of the plurality of applicants participating.

For each applicant, a “fit” score may then be calculated by the controller processor 3 via the software application of the assessment system 1, in step 105, for each theme for each program they’re applying to and preferably each and every program, as described herein after. Each fit score may be calculated by comparing their ranking of the characteristics, i.e. applicant’s prioritized list of characteristics 30, within each theme to each program’s overall ranking, e.g. program’s prioritized list of the characteristics 20 within that category (theme).

The comparison for the “fit” scores may utilize Spearman’s or Kendall’s rank correlation coefficient for paired comparison analysis done without sliding scale, Pearson’s correlation when done with sliding scale, or any other suitable rank correlation method.

In step 106, the assessment system 1 may send, whereby each program’s representative may receive, e.g. via email or letter, a list 50 including each individual fit score, for each theme, for each applicant that applied to their program, e.g. “Fit: Culture”, “Fit: Pedagogy”, and “Fit: Work Environment”, and/or an overall fit score. At step 107, a ranked list 60 of all applicants interested in the program, whereby each program’s representative, e.g. via email or letter, may be provided in a compiled list in a particular order, e.g. descending overall fit score, as detailed hereinbelow, in a Prep guide.

All other data collected, e.g. the actual rank of the characteristics within each theme, the ranking of the three themes, may or may not be shared with the programs, at step 110, and research may be conducted on this data to determine where else the programs or the applicants may find meaning and value, and provided to each program for future applicant recruitment, at step 111.

In step 108, the assessment system 1 may send, whereby each applicant may receive, e.g. via email or letter, each individual fit score for each category for each program they applied to. Each applicant may also receive, at step 109, a compiled and sorted list of all programs they applied to in order of average fit score and/or in order of adjusted fit score based on the adjusted fit score calculation provided by the program. As well, the applicant may receive a list of programs to which they did not apply, but which ranked most highly in strength of fit score to that applicant’s fit score, at step 112. However, each applicant may not receive the adjusted fit score nor their overall rank in each program’s list. The applicant may receive a limited amount of more detailed information regarding their fit with individual programs, at step 113, to enable reconsideration of their application pattern, but to deter gamesmanship, not sufficient detail to allow an applicant to reverse engineer/calculate an individual program’s strength of values assigned to individual characteristics within individual categories (themes).

The fit scores quantify the strength of the association between the program’s overall ranking of each category (theme) of characteristics, and the applicant’s ranking of the category (theme) of characteristics. The fit score may range from 0 to 100. With paired comparison analysis without sliding scales, with reference to FIG. 10A, a fit score of 100 indicates that the applicant has ranked all characteristics in the exact same order as the program rating. With reference to FIG. 10B, a fit score of 50 indicates that the applicant and the program rankings have no discernible pattern. With reference to FIG. 10C, a fit score of 0 indicates that the applicant has ranked all characteristics in the exact opposite order of the program rating. With sliding scales, the fit scale may be similarly transformed onto a scale of 0 to 100.

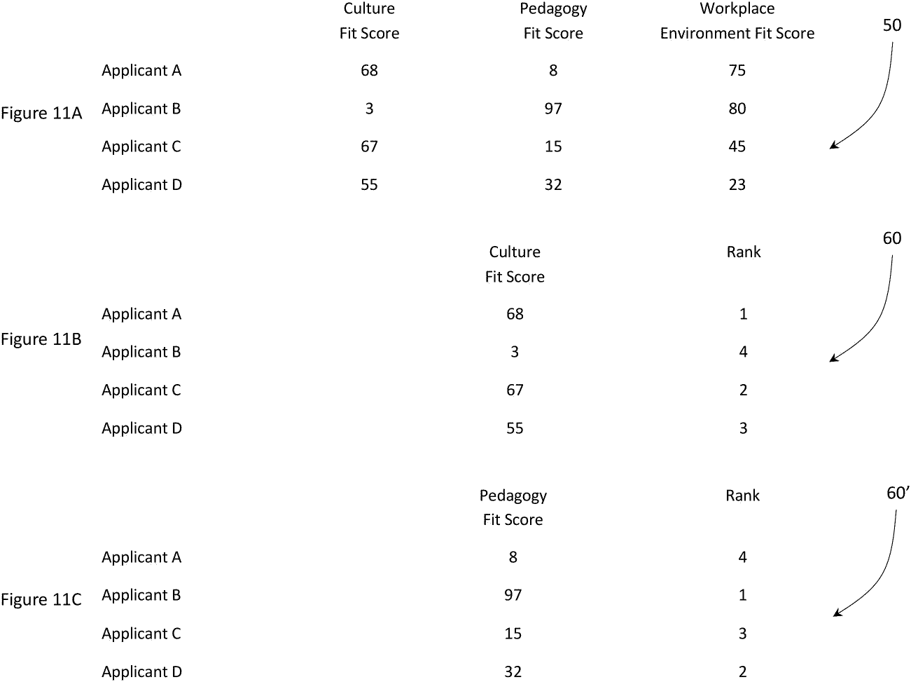

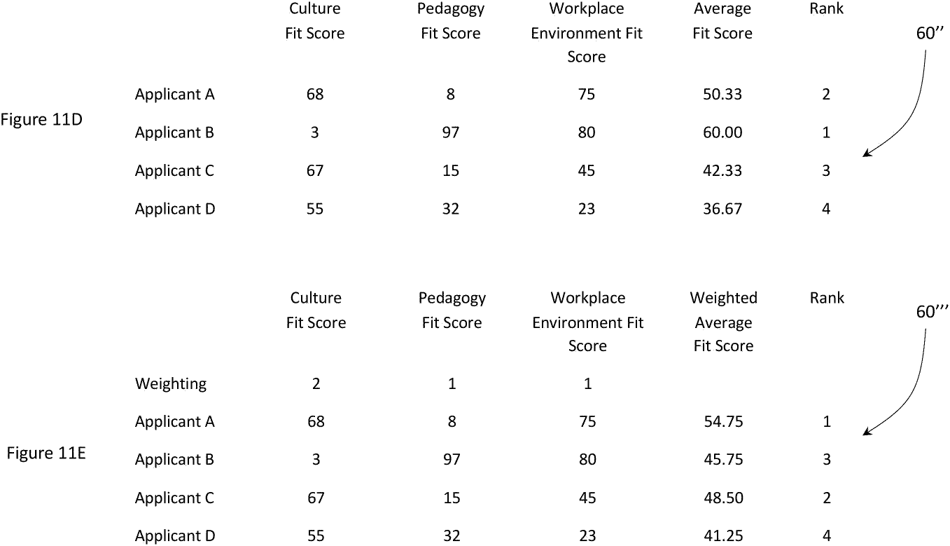

With reference to FIGS. 11A to 11E, there are a number of ways that each program may interpret the fit scores to enable the assessment system 1 to generate a ranked list of applicants. Each program may choose to focus impressionistically on one or two categories they prioritize most as a program by disproportionately weighting one or two of the fit scores over the others resulting in a disproportionately weighted average. For example, with reference to FIG. 11B, some programs, who value culture most, may request or establish a ranked list 60, which prioritizes Applicant A, because of their highest fit score (68), and reject Applicant B, because of their lowest fit score (3), i.e. weigh culture fit score 100% and other fit scores 0%. Meanwhile, with reference to FIG. 11C, some programs who value pedagogy most may request or establish a ranked list 60′, which selects Applicant B, because of their highest fit score (97) to receive a spot in their program and rejects Applicant A, because of their lowest fit score (8) i.e. weigh pedagogy fit score 100% and other fit scores 0%. Details of the disproportionately weighted average, e.g. formula for weighing one fit score more than the others, may be entered by the representatives of each program or under direction thereof via the graphic user interface 10 during the initial assessment stage or at any time thereafter.

With reference to FIG. 11D, some programs may request or establish a ranked list 60″, to take an average of the three fit scores to derive an overall fit score, and use that average to compare or rank the applicants.

Alternatively, with reference to FIG. 11E, each program may request or establish a ranked list 60’’’, to calculate a weighted average of the three fit scores based on the category or categories they prioritize most as a program, and use that weighted average to compare or rank applicants. In the illustrated example, one of the categories, e.g. culture, is prioritized twice as much as the other categories.

Each fit score may be computed by the assessment system 1 by first calculating the rank correlation between each applicant’s ranking of characteristics 30 for each theme, and the corresponding ranking for each program they are applying to, i.e. the program’s overall prioritized list of characteristics 20. The rank correlation may be calculated using a suitable rank correlation formula, such as one of Spearman’s rho or Kendall’s tau or a combination of both, such as Spearman’s rho/ Kendall’s tau, with values ranging from -1 (perfect negative correlation) to +1 (perfect positive correlation), with 0 signifying no association.

The rank correlation may then be transformed using the following equation

Fit = 50x + 50

to derive the final fit score, where x is the rank correlation. The transformation enables easier interpretation of the fit scores, i.e. the scaling (multiplication) transformation makes the scores larger and easier to interpret, and the shift (addition) transformation ensures all scores are positive, with a minimum of 0 and a maximum of 100.

For the programs, the value of the assessment system 1 includes:
1) Identifying the small number of applicants whose fit/alignment is at the very opposite end of the spectrum to those of the program;
2) For use as an additional data point for the small pool of applicants vying for the final interview spots;
3) For use to prioritize those who highly align with the program’s values and mission for interview invitations;
4) For use to prioritize applicants during their ranking by the program, for applicants who are otherwise equal in all other respects.

For the applicants the value of the assessment system 1 includes: helping in identifying those programs whose values most resonate with their own for the purpose of deciding on relative investment of time, money and other personal resources.

The assessment system 1 may also generate and transmit to one or more selected applicants an applicant guidance report, at step 112, which identifies to each of the selected applicants a list of the programs that they did not select or apply for, but that nevertheless ranked relatively high, e.g. over a predetermined threshold, in the applicant to program alignment fit score calculations. Similarly, the assessment system 1 may also generate and transmit to one or more selected programs a program guidance report, at steps 110 and 111, which identifies general features of applicants, preferably without clear identification, who did not consider that program acceptable despite ranking highly in the applicant to program alignment calculations. The program guidance report may provide insight into general features, e.g. geographic, gender, age, socio-economic, race etc. of applicants, who ranked relatively high, e.g. over a predetermined threshold, in the applicant to program alignment fit score calculations, but did not apply to their program to guide programs for future targeted marketing of their program. The program guidance report may also provide insight into general features, e.g. geographic, gender, age, socio-economic, race etc. of applicants, who did not rank highly in the applicant to program alignment calculations, to guide programs for future changes of their program that may be required.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. A method comprising:
a) providing, by a processor, one or more first graphic user interfaces configured to enable each of a plurality of applicants to enter a respective first prioritized list of a first plurality of characteristics in a first category relating to one or more positions offered by each of a plurality of programs into which the plurality of applicants wish to apply;
b) providing, by the processor, one or more second graphic user interfaces configured to enable one or more representatives of each of the plurality of programs to enter a second prioritized list of the first plurality of characteristics in the first category;
c) determining, by the processor, a first ranked correlation between each first prioritized list and each second prioritized list;
d) generating, by the processor, a corresponding first fit score for each of the plurality of applicants for each of the plurality of programs based on the first ranked correlations;
e) generating, by the processor, for each of the plurality of programs, a corresponding ranked list of the applicants that applied thereto, based on the corresponding first fit scores;
f) sending the corresponding first fit score to each of the plurality of applicants for each of the plurality of programs that they applied to; and
g) sending the corresponding ranked list of the applicants to each of the plurality of programs.

2. The method according to claim 1,
wherein the one or more first graphic user interfaces are configured to enable each of the plurality of applicants to enter a third prioritized list of a second plurality of characteristics in a second category relating to the one or more positions offered by each of the plurality of programs into which the plurality of applicants wish to apply;
wherein the one or more second graphic user interfaces are configured to enable the one or more representatives of each of the plurality of programs to enter a fourth prioritized list of the second plurality of characteristics in the second category;
further comprising:
determining, by the processor, a second ranked correlation between each third prioritized list and each fourth prioritized list, and generating a corresponding second fit score for each of the plurality of applicants for each of the plurality of programs based on the second ranked correlations;
generating, by the processor, for each of the plurality of programs, the corresponding ranked list of the applicants based on the corresponding first fit scores and the corresponding second fit scores; and
sending the corresponding second fit score to each of the plurality of applicants.

3. The method according to claim 2, wherein one or more of the corresponding ranked lists of applicants is based on a disproportionately weighted average of the first fit score and the second fit score; and wherein the one or more second graphic user interfaces are configured to enable the one or more representatives of each of the plurality of programs to enter details of the disproportionately weighted average.

4. The method according to claim 2, wherein step a) includes presenting to each applicant a first series of forced choice comparisons including pairs of the first plurality of characteristics to choose from; and
wherein step c) includes determining the first ranked correlations based on results of the first series of forced choice comparisons.

5. The method according to claim 4, wherein step a) includes presenting to each applicant the first series of forced choice comparisons including the pairs of the first plurality of characteristics with a sliding scale to choose from.

6. The method according to claim 4, wherein step b) includes presenting to each representative a second series of forced choice comparisons including the pairs of the first plurality of characteristics to choose from; and
wherein step c) includes determining the first ranked correlations based on results of the second series of forced choice comparisons.

7. The method according to claim 1, wherein the first ranked correlation is based on a rank correlation formula, selected from one or more of Spearman’s rho, Kendall’s tau, or Pearson’s correlation.

8. The method according to claim 7, wherein the first fit score is generated according to the formula: fit score = 50 x the first ranked correlation + 50.

9. The method according to claim 2,
wherein the one or more first graphic user interfaces are configured to enable each of the plurality of applicants to enter a fifth prioritized list of a third plurality of characteristics in a third category relating to the one or more positions offered by each of the plurality of programs into which the plurality of applicants wish to apply;
wherein the one or more second graphic user interfaces are configured to enable the one or more representatives of each of the plurality of programs to enter a sixth prioritized list of the third plurality of characteristics in the third category;
further comprising:
determining, by the processor, a third ranked correlation between each fifth prioritized list and each sixth prioritized list, and generating a corresponding third fit score for each of the plurality of applicants for each of the plurality of programs based on the third ranked correlations;
generating, by the processor, for each of the plurality of programs, the corresponding ranked list of the applicants based on the corresponding first fit scores, the corresponding second fit scores, and the corresponding third fit scores; and
sending the corresponding third fit score to each of the plurality of applicants.

10. The method according to claim 1, further comprising:
generating, by the processor, for a selected one of the plurality of programs, a guidance report including general features of applicants that did not apply to the selected program, but generated corresponding first fit scores over a predetermined threshold; and
sending the guidance report to the selected one of the plurality of programs.

11. The method according to claim 1, further comprising:
generating, by the processor, for a selected applicant of the plurality of applicants, a guidance list of the programs that the selected applicant did not apply to, but generated corresponding first fit scores over a predetermined threshold;
sending the guidance list to the selected one of the plurality of applicants.

12. A computing apparatus for providing a program assessment comprising:
a first processor; and
a first memory storing instructions that, when executed by the processor, configure the computing apparatus to:
a) provide one or more first graphic user interfaces configured to enable each of a plurality of applicants to enter a respective first prioritized list of a first plurality of characteristics in a first category relating to one or more positions offered by each of a plurality of programs into which the plurality of applicants wish to apply;
b) provide one or more second graphic user interfaces configured to enable one or more representatives of each of the plurality of programs to enter a second prioritized list of the first plurality of characteristics in the first category;
c) determine a first ranked correlation between each first prioritized list and each second prioritized list,
d) generate a corresponding first fit score for each of the plurality of applicants for each of the plurality of programs based on the first ranked correlations;
e) generate for each of the plurality of programs, a corresponding ranked list of the applicants that applied thereto based on the corresponding first fit scores;
f) send the corresponding first fit score to each of the plurality of applicants for each of the plurality of programs that they applied to; and
g) send the corresponding ranked list of the applicants to each of the plurality of programs.

13. The apparatus according to claim 12,
wherein the one or more first graphic user interfaces are configured to enable each of the plurality of applicants to enter a third prioritized list of a second plurality of characteristics in a second category relating to the one or more positions offered by each of the plurality of programs into which the plurality of applicants wish to apply;
wherein the one or more second graphic user interfaces are configured to enable the one or more representatives of each of the plurality of programs to enter a fourth prioritized list of the second plurality of characteristics in the second category;
wherein the instructions that, when executed by the processor, also configure the computing apparatus for:
determining, by the processor, a second ranked correlation between each third prioritized list and each fourth prioritized list, and generating a corresponding second fit score for each of the plurality of applicants for each of the plurality of programs based on the second ranked correlations;
generating, by the processor, for each of the plurality of programs, the corresponding ranked list of the applicants based on the corresponding first fit scores and the corresponding second fit scores; and
sending the corresponding second fit score to each of the plurality of applicants.

14. The apparatus according to claim 12, wherein a) includes presenting to each applicant a first series of forced choice comparisons including pairs of the first plurality of characteristics to choose from; and
wherein c) includes determining the first ranked correlations based on results of the first series of forced choice comparisons.

15. The apparatus according to claim 14, wherein a) includes presenting to each applicant the first series of forced choice comparisons including the pairs of the first plurality of characteristics with a sliding scale to choose from.

16. The apparatus according to claim 14, wherein b) includes presenting to each representative a second series of forced choice comparisons including the pairs of the first plurality of characteristics to choose from; and
wherein c) includes determining the first ranked correlations based on results of the second series of forced choice comparisons.

17. The apparatus according to claim 12, wherein the first ranked correlation is based on a rank correlation formula, selected from one or more of Spearman’s rho, Kendall’s tau, or Pearson’s correlation.

18. The apparatus according to claim 17, wherein the first fit score is generated according to the formula: fit score = 50 x the first ranked correlation + 50.

19. The apparatus according to claim 12, wherein the one or more first graphic user interfaces are configured to enable each of the plurality of applicants to enter a fifth prioritized list of a third plurality of characteristics in a third category relating to the one or more positions offered by each of the plurality of programs into which the plurality of applicants wish to apply;
wherein the one or more second graphic user interfaces are configured to enable the one or more representatives of each of the plurality of programs to enter a sixth prioritized list of the third plurality of characteristics in the third category;
wherein the instructions that, when executed by the processor, also configure the computing apparatus for:
determining, by the processor, a third ranked correlation between each fifth prioritized list and each sixth prioritized list, and generating a corresponding third fit score for each of the plurality of applicants for each of the plurality of programs based on the third ranked correlations;
generating, by the processor, for each of the plurality of programs, the corresponding ranked list of the applicants based on the corresponding first fit scores, the corresponding second fit scores, and the corresponding third fit scores; and
sending the corresponding third fit score to each of the plurality of applicants.

20. The apparatus according to claim 13, wherein the instructions that, when executed by the processor, also configure the computing apparatus for:
generating, by the processor, for a selected one of the plurality of programs, a guidance report including general features of applicants that did not apply to the selected program, but generated corresponding first fit scores over a predetermined threshold; and
sending the guidance report to the selected one of the plurality of programs.

21. The apparatus according to claim 12, wherein the instructions that, when executed by the processor, also configure the computing apparatus for:
generating, by the processor, for a selected applicant of the plurality of applicants, a guidance list of the plurality of programs that the selected applicant did not apply to, but generated corresponding first fit scores over a predetermined threshold; and
sending the guidance list to the selected one of the plurality of applicants.
